(19) United States
(12) Patent Application Publication
(10) Pub. No.: US 2013/0320849 A1
(43) Pub. Date: Dec. 5, 2013

(54) DEVICE FOR OPERATING A LAMP UNIT

(71) Applicant: Hella KGaA Hueck & Co., Lippstadt (DE)

(72) Inventor: Ralf Edelmeier, Herzebrock-Clarholz (DE)

(21) Appl. No.: 13/900,700

(22) Filed: Aug. 20, 2013

(30) Foreign Application Priority Data
May 23, 2012 (DE) 102012104434.1

(51) Int. Cl. H05B 33/08

(52) U.S. Cl. CPC H05B 33/0842; H05B 33/0896
USPC 315/77

(57) ABSTRACT

The invention relates to a device for operating a lamp, in particular in a vehicle, wherein the lamp is coupled to a controller for energy-related supply of the lamp, and a data channel is present between the controller and the control unit.

It is inventively provided that the controller and the control unit exchange characteristic data of the lamp, in particular current parameter data, temperature protection data, socket current data, or the like via the data channel, and the controller has an indicator with an indicator value, wherein in the instant of a first initialization of the controller, the characteristic data can be transmitted from the controller to the control unit depending on the indicator value.

The invention relates to a device for operating a lamp, wherein the lamp is coupled to a controller for energy-related supply of the lamp and a data channel is present between the controller and a control unit. Further, the invention relates to a method for operating a lamp, wherein the lamp is coupled to a controller for energy-related supply of the lamp and a data channel is present between the controller and a control unit. The lamp can be provided in particular in a vehicle.

### PRIOR ART

It is known from DE 101 14 124 A1 that a controller is used for energy-related supply of a lamp for motor vehicles. Since different lamps have different nominal currents, a coding element is arranged for clear nominal current determination of the lamp. This coding element has thereby a value than can be read from the controller. By means of this value of the coding element, the controller can determine the necessary nominal current for the lamp, wherein said nominal current can be adjusted by the controller for the lamp. However, it has proven to be disadvantageous that a higher technical expense is necessary in order to read the coding element from the controller. In addition, an increased technical manufacturing expense is necessary, since the coding element must be additionally coupled to the lamp. In addition, sufficient installation space for the coding resister is not always present on a lamp bracket. The use of a coding PCB is also logistically difficult to control and means an additional component, in particular in a head light of a motor vehicle. When using coding resistors on a lamp bracket, an additional expense occurs due to the necessary plug contacts and lines. In the case that the nominal current for the lamp is adjustable using software in the control device, then during an exchange of the control device an additional coding resistor is necessary for adapting the nominal current.

### DISCLOSURE OF THE INVENTION

It is the object of the present invention to provide a device and a method for operating a lamp unit, in particular in a motor vehicle, wherein the device and the method are technically simple and reliably constructed to enable a safe and reliable adjustment of the nominal current, in particular during an exchange of the control device for the lamp.

The solution to this problem is proposed by a device with the features of claim 1 and a method with the features of claim 7, in particular by the features of the respective characterizing parts. Preferred embodiments are described in the dependent claims.

It is inventively provided that the controller and the control unit exchange characteristic data, in particular current parameter data, temperature protection data, socket current data, or the like, of the lamp via the data channel, and the controller has an indicator with an indicator value, wherein in the instant of a first initialization of the controller, the characteristic data can be transmitted from the controller to the control unit depending on the indicator value. Thus, the control unit now commands the characteristic data from the controller so that said controller—e.g., in case of a defect in the controller—can if necessary be exchanged without allowing the characteristic data, which are necessary for operating the lamp, to be lost. A newly installed or exchanged controller can then receive the characteristic data from the vehicle-internal control unit in order to correctly control the lamp. By this means, the lamp does not require any other coding elements since the characteristic data are at least also present in the control unit.

The invention is characterized by the fact that characteristic data are exchanged between the controller and the control unit via the data channel; in particular, in the case of an exchange of the controller, the necessary and already present characteristic data of the lamp can be transferred from the control unit to the newly installed controller.

During the first start up of the preprogrammed controller with the characteristic data in a new vehicle, the data exchange only takes place at a specific indicator value of the indicator, which can be read from the controller. Said indicator value can be read from the controller in the instant of the first initialization between the control unit and the controller, wherein, depending on the indicator value, the characteristic values which are stored in the controller are transmitted to the control unit. The controller thereby functions as master, which signals the control unit that the same should set itself to receive data. After the vehicle-internal control unit has set itself for data reception, the characteristic data are transmitted from the controller to the control unit. After the transmission of the characteristic data, the indicator value of the indicator can by changed by the controller in such a way that during a next initialization of the controller, said controller does not function as master and by this means a further transmission of the characteristic data can be avoided. By this means, a renewed redundant data exchange between the control unit and the controller can also be effectively prevented during a renewed initialization of the controller.

In addition, characteristic data can be transferred from the control unit to the controller, in particular during an exchange for a new controller, which lacks the characteristic data for operating the lamp. The indicator in the new controller can thereby possess a specific indicator value, wherein the controller likewise logs on as master at the control unit; however, the controller thereby signals to the control unit, that the characteristic data should be transmitted from the control unit to the controller. In addition, a second indicator can be adjusted, wherein depending on the indicator value of the second indicator, the characteristic data are either transmitted from the controller to the control unit, or the characteristic data are transmitted from the control unit to the controller. The characteristic data can thereby contain additional operating parameters as well as identification specifications for the lamp. The identification specifications can thereby consist of the manufacturer specifications and/or clear identification values, in particular a serial number. It is additionally conceivable that the characteristic data and the indicator value in the controller can be changed via an interface arranged on the controller. By this means, an exchange of the lamp with other characteristic data can take place, wherein a flawless operation of the lamp by the controller can be guaranteed. The indicator value in the controller is thereby set to a value, which identifies the controller as master during a next initialization. Thereafter, the controller as master transmits the new characteristic data of the lamp to the control unit, which have been entered via the interface of the controller. In conclusion to this, the indicator value can be changed by the controller in such a way that no further data exchange of the characteristic data can take place between the controller and the control unit during an initialization.

In addition to the possibility of using preprogrammed controllers, it is advantageous to save the characteristic data in the controller, e.g., during the production of a headlamp for a motor vehicle, so that deviations between individual lamps in the headlamp production can be considered directly in the characteristic data.

It is advantageous that the control unit and the controller each have a data storage. The data storage for the controller can thereby store the characteristic data for the lamp as well as identification data for the controller. Non-volatile data storage can thereby be used, in particular flash memory, which has the advantage that the data can be stored without permanent supply voltage. It is further conceivable that a hard drive can be used. Since the control unit also has a data storage available, the characteristic data can thus be transferred from the controller to the control unit and persistently stored.

It is further advantageous that several lamps are constructed into a module, wherein in particular the lamps are equipped as LEDs (light emitting diodes) or OLEDs (organic light emitting diodes). Due to this modular construction, the light intensity of the lamp can be increased. In addition, light emitting diodes are characterized by the increased lifespan thereof in contrast to conventional lamps life, e.g., incandescent lamps, which are temperature emitters. In addition, they emit light in a limited spectral range so that said light is almost monochromatic. By this means, e.g., LEDs achieve a light efficiency of up to 160 lumens per watt. The efficiency of a light emitting diode is thereby much greater than that of a classic incandescent lamp. It is particularly advantageous in the case of light emitting diodes in comparison to conventional lamps, e.g., incandescent lamps, that diode elements can be switched on and off very quickly. Since several lamps can be switched in parallel into a module, the failure of one lamp does not result in a complete failure of the light emission from the module. It is additionally conceivable that several lamps can be switched in series, wherein a combined parallel and series switching of lamps in a module is conceivable. Several modules can also be controlled by one and the same controller.

It is facultatively conceivable that a coding element, in particular a coding resistor, is arranged on at least one lamp, and said coding element can be read from the controller. By means of this coding element, a coding of the nominal current to be committed to memory for the lamp can result. The coding can thereby be read and evaluated via the controller. It is additionally conceivable that the coding represents further characteristic data of the lamp. The coding element, which can be equipped as a coding resistor, can thereby be arranged on the lamp independent of the circuit configuration of the lamp. Thus, the determination of characteristic data of the lamp can take place redundantly from the controller, so that, e.g., in the case of a defect of the data line, the characteristic data can still be determined by the controller.

It is further advantageous that several different lamps can be operated independently from one another by the controller. By this means, different types of lamps, which have different characteristic data, can be connected to only one controller. The controller can thus transmit several different characteristic data about different lamps to the control unit. By this means, several lamps can be controlled independent of one another so that, e.g., the light intensity can be increased or decreased by a simple on and off switching of the lamp. In addition, it is possible to control different lamps for different functions, in particular in a motor vehicle, independent of one another using the same controller. Different lamps of different construction can also be considered, in particular a combination of temperature emitters and light emitting diodes. Different color spectra can thereby be used. By this means, a circuit configuration of the controller for regulating the light intensity and/or the color spectrum and/or specific function units of the lamp, in particular in a motor vehicle, can take place technically more easily.

Advantageously, the data channel and a supply line can be constructed as a unified component. It is thereby conceivable that the supply line functions simultaneously as the data channel, wherein data can be transmitted via the supply line with the aid of a modulation process. By this means, the number of cables required between the controller and the control unit can be reduced. However, multiple cable elements in a unified component are also conceivable, wherein the supply line and the data line are embedded separated from one another in the component according to cable technology, so that an installation of the supply line and the data channel between the controller and the control unit can be facilitated, in particular during vehicle manufacturing.

The inventive problem is likewise solved by a method for operating a lamp, wherein the lamp is coupled to a controller for energy-related supply of the lamp and a data channel is present between the controller and a control unit. In addition, it is inventively provided that the controller and the control unit exchange characteristic data of the lamp, in particular current parameter data, temperature protection data, socket current data or the like, via the data channel, and the controller has an indicator with an indicator value, wherein at the moment of a first initialization of the controller, the characteristic data can be transmitted from the controller to the control unit depending on the indicator value.

The inventive method is characterized by a rule-based data exchange of characteristic data which are necessary for operating the lamp. The time point of the data exchange between the control unit and the controller as well as the transfer direction can thereby also be determined via specified indicator values. The controller can thereby function as master to regulate the control of the data transmission of the characteristic data.

It is hereby conceivable that the controller changes the indicator value of the indicator according to a specified rule, in particular after the initialization of the controller and the transmission of the characteristic data from the controller to the control unit. The indicator can thereby be a simple flag that merely has one binary value. It is thus likewise conceivable that if the indicator value has the value 0, then the controller does not designate itself as master during the initialization and therefore no characteristic data can be exchanged between the controller and the control unit. In contrast, it is additionally conceivable that characteristic data are exchanged between controller and control unit when the flag has a value of 1, since in this case the controller could initialize as master. After a successful transmission of the characteristic data, the flag can be set from 1 to 0 so that no characteristic data are transmitted between the controller and the control unit during a further initialization of the controller. However, the indicator value can also assume more complex expressions so that by means of these expressions only specified data are exchanged between the controller and the control unit. A specified characteristic value could thus be transmitted in a targeted fashion from the controller to the control unit by means of the indicator value, like current parameter data of the lamp, or temperature protection data, or socket current data, or the like.

One can naturally conceive of different indicator values, which provide a transmission of combined characteristic values.

It is advantageous that data, in particular the characteristic data, are persistently stored in a data storage in the controller and the control unit. By this means, it can be guaranteed that the characteristic data remain retained even during an energy-related interruption of the device. This is advantageous for using the device, in particular in a motor vehicle, since during an exchange of the vehicle battery, the data are retained and no additional expense is caused thereby, since the necessary characteristic data do not have to be retransmitted to the controller and/or control unit.

The present invention is also directed at a vehicle with the inventive device and/or the method.

Further measures and advantages of the invention arise from the claims, the subsequent description, and the drawings. The disclosed features from the inventive method also likewise apply for the inventive device and vice versa. The invention is depicted in several embodiments in the drawings. The features thereby mentioned in the claims and in the description can each be essential individually or in any combination. As is seen in:

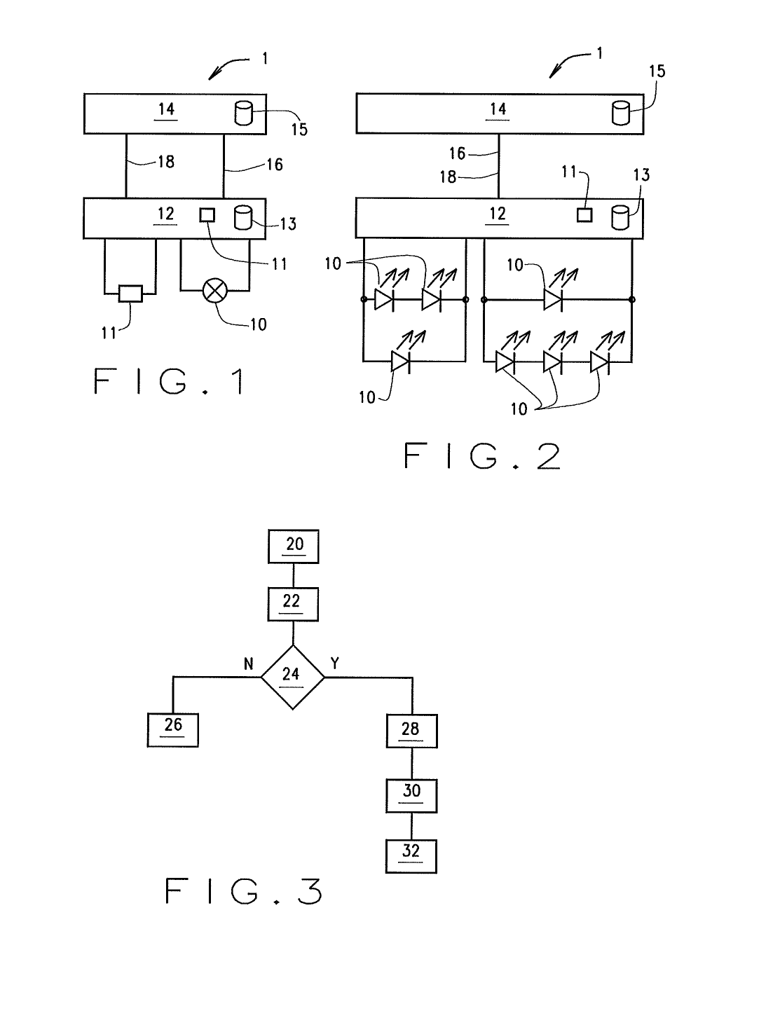

FIG. 1 a schematic view of the inventive device with one controller and one control unit,

FIG. 2 a schematic view of the device, in which several lamps are constructed into a module having several lamps, and

FIG. 3 a diagram in which the sequence of the inventive method is depicted.

FIG. 1 depicts the inventive device 1 with a control unit 14 which has a data storage 15. The control unit 14 is, for example, connected to the controller 12 via a supply line 18 and a data channel 16. The controller 12 has a data storage 13 and an indicator 17. At least one lamp 10 and a facultatively present coding element 11, which is here embodied as coding resistor 11, is coupled to the controller 12. The indicator 17 has a specified indicator value. The controller 12 can read the indicator value from the indicator 17 and, depending on the indicator value, the characteristic data are transmitted from the controller 12 to the control unit 14 or vice versa. It is additionally conceivable that the data are also bidirectionally exchangeable between the control unit 14 and the controller 12. The data channel can thereby be designed as a bus system, in particular as a CAN bus. The time point for reading the indicator value 17 can thereby take place at the moment of the initialization of the controller 12. The initialization can thereby be implemented basically during the start up, i.e., the beginning of the energy-related supply of the controller 12. However, other triggers for data transfer between the control unit and the controller are also conceivable, like an initiation of the initialization via a defined interface on the controller 12. In addition, the initialization of the controller could be electronically implemented via the control unit 14. A button on the controller 12 is also conceivable, said button forces the initialization of the controller 12 upon activation via a switch. The indicator value can thereby be set during the production of the controller to a defined value. Since the use of the device 1 in a motor vehicle is conceivable, it can likewise be sensible to be able to set the indicator value to a specified value via an interface reachable for this purpose, e.g., in the form of a service box for a technician. The supply line 18 in FIG. 1 is connected directly between the control unit 14 and the controller 12. However, the energy-related supply of the controller 12 can also optionally take place via another energy source, i.e., a supply takes place independent of the control unit 14.

FIG. 2 embodies a second embodiment of a device 1, in which the control unit 14 is coupled to the controller 12 via a combined data/supply channel 16, 18. The data/supply channel 16, 18 is thereby constructed as a unified component. The control unit 14 has a data storage 15. The controller 12 likewise has a data storage 13 and an indicator 17. The data storage 13, 15 can thereby be designed as transient or persistent data memory. For example, two light modules with lamps 10 are coupled to the controller 12, said modules can be respectively controlled independent of one another by the same controller 12. The lamps are thereby designed as LEDs which comprise in the respective light module a parallel circuit and a series circuit of LEDs. However, other lamps 10 can also be used provided these emit light in a visible range, in particular OLEDs.

FIG. 3 depicts a flow chart, wherein in a first step 20, the initialization of the controller 12 during the start up of the device takes place. In a second step 22, the indicator value of the controller 12 is read, wherein depending on the indicator value, a decision 24 is made whether the characteristic data are transmitted from the controller 12 to the control unit 14. If the indicator value should not have a value which triggers a specified rule in the control unit for data transference, then in a next step 26 the controller 12 takes over the regulation tasks for the lamp 10 of the device 1 using characteristic data available in the controller 12. In the case that the indicator value has a value which triggers a specified rule in the controller 12 for the data transference, the controller 12 logs in as master at the control unit 14 in a next step 28. Thus, according to the rule, the characteristic data are transmitted to the control unit 14, wherein depending on the rule, different characteristic data can be transmitted to the control unit 14. In the next step 30, the indicator value is reset to a value which does not necessitate a data exchange during an initialization of the controller 12. Finally, in a step 32, the controller 12 takes over the regulation tasks for the light 10 using the currently available characteristic data. In addition, an initialization can take place automatically in the controller 12 at fixed time periods, and/or the setting of the indicator value can take place in such as way that an exchange of the characteristic data takes place between the controller 12 and the control unit 14 in regular time intervals. Depending on the indicator value set, a selective data exchange between the control unit 14 and the controller 12 is also possible.

### LIST OF REFERENCES

1 Device
10 Lamp
11 Coding element
12 Controller
13 Data storage
14 Control unit
15 Data storage
16 Data channel
17 Indicator
18 Supply line
20 Initialization
22 Reading
24 Evaluation
26 Take over task control unit
28 Controller is master
20 Change of the indicator value
32 Take over task control unit

1. A device for operating a lamp, in particular in a vehicle, comprising:
a controller for energy-related supply of the lamp and a control unit with a data channel present between the controller and the control unit;
wherein the controller and the control unit are operable to exchange characteristic data of the lamp via the data channel;
said controller further comprising an indicator having an indicator value, wherein at the moment of a first initialization of the controller, the characteristic data of the lamp is transmitted from the controller to the control unit depending on the indicator value.

2. The device according to claim 1, wherein each of said control unit and said controller are provided with a data storage.

3. The device according to claim 1, wherein said lamp comprises a plurality of lamps arranged in a module, wherein in particular the lamps (10) are equipped as LEDs (light emitting diodes) or OLEDs (organic light emitting diodes).

4. The device according to claim 1, further comprising at least one coding element arranged on the lamp and which can be read from the controller.

5. The device according to claim 1, wherein said lamp comprises a plurality of lamps and wherein said controller is operable to independently operate each of said plurality of lamps.

6. The device according to claim 1, further comprising a supply channel between said controller and said control unit.

7. A method for operating a lamp, in particular in a vehicle, comprising the steps of:
coupling the lamp to a controller (12) for energy-related supply of the lamp (10);
providing a control unit, said control unit having an indicator with an indicator value, and a data channel between the controller and the control unit;
exchanging characteristic data of the lamp between the controller and the control unit via the data channel (16); and
at the moment of a first initialization of the controller, transmitting the characteristic data from the controller to the control unit depending on the indicator value.

8. The method according to claim 7, further comprising the step of changing the indicator value of the indicator according to a specified rule, in particular after the initialization of the controller and the transmission of the characteristic data from the controller to the control unit.

9. The method according to claim 7, wherein said controller and said control unit are each provided with a data storage and further comprising the step of storing said characteristic data in said data storage.

10. The method according to claim 7, wherein said characteristic data is selected from the group consisting of current parameter data, temperature protection data, and socket current data.

11. The device of claim 1, wherein said characteristic data is selected from the group consisting of current parameter data, temperature protection data, and socket current data.

12. The device according to claim 3, wherein said plurality of lamps are LEDs (light emitting diodes).

13. The device according to claim 3, wherein said plurality of lamps are OLEDs (organic light emitting diodes).

14. The device according to claim 4, wherein said at least one coding element is a coding resistor.

15. The device according to claim 6, wherein said supply channel and said data channel are provided as a unified component.
